(19) United States
(12) Patent Application Publication
(10) Pub. No.: US 2014/0321954 A1
(43) Pub. Date: Oct. 30, 2014

(54) COMBINATION TRUCK LOADING DEVICE

(71) Applicant: Johnnie Keen, Henderson, KY (US)

(72) Inventor: Johnnie Keen, Henderson, KY (US)

(21) Appl. No.: 13/871,358

(22) Filed: Apr. 26, 2013

(51) Int. Cl. B60P 1/43

(52) U.S. Cl. CPC B60P 1/431
USPC 414/537; 414/813

(57) ABSTRACT

A combination loading device for a truck comprising a running board enclosure, where the running board enclosure attaches to a side of the truck to serve as a running board; an inner cavity within the running board enclosure; a loading ramp within the inner cavity of the running board enclosure, where the loading ramp attaches to a truck bed; an attachment end of the loading ramp, where the attachment end fastens to the truck bed; and a loading end of the loading ramp at an opposite end from the attachment end, where the loading end rests on the ground during use.

### BACKGROUND OF THE INVENTION

1. Field of the Invention

The present invention relates to a truck accessory that provides a side running board and a truck ramp combined into a single device.

2. Description of Related Art

Pickup trucks are vehicles commonly used to haul items. The trucks include accessories that aid a user to load the items into both the truck cabin and bed. The height of the truck cabin is often high off the ground due to the heavy loads that they are capable of carrying. To assists drivers and passengers to enter into the cabin, running boards are attached to each side of the truck. The running boards provide a step for the user to enter the vehicle. Likewise, many pickup trucks come equip with loading ramps that fasten to the truck bed. The loading ramps provide an angled surface upon which heavy items may be driven or wheeled onto the bed. Both of these accessories are helpful tools that make owning and operating a pickup truck much more convenient.

Recently developments have been made to combine running boards and loading ramps into a single, multipurpose tool. For example, U.S. Pat. No. 6,520,523 by Bradley L. Beck discloses a removable vehicle running board. The running board detaches from the side of the pickup and then easily fastens to the lip of the truck bed for loading. Similarly, U.S. Pat. No. 6,592,135 by Theron V. Hendrix discloses a vehicle running board detachable for use as a loading rap. The running board is attached to the side of the truck with L-shaped brackets, and a locking pin. Finally, U.S. Pat. No. 7,708,294 by Robert L. Demick discloses a detachable dual-use platform apparatus and method. The detachable platform is attached to the side of the vehicle with hooking mechanisms that lock to secure placement. While these devices provide the convenience of a multipurpose tool their use may be cumbersome continuously attaching and detaching the large platforms.

Therefore, it would be beneficial in the art to provide a loading device that serves to provide a running board and a loading ramp that is easy to change between the side and back loading positions. It would also be desirable in the art to provide a loading device that is compact when not in use.

### SUMMARY OF THE INVENTION

In view of the foregoing disadvantages inherent in the prior art, the general purpose of the present invention is to provide a combination running board and loading ramp for a truck, configured to include all of the advantages of the prior art, and to overcome the drawbacks inherent therein.

Accordingly, an object of the present invention is to provide a combination loading device that attaches to the side a truck and then unfolds to lengthen the surface of the ramp when attached as a loading ramp.

Another object of the present invention is to provide a combination loading device that provides a storage enclosure to serve as a running board, and then further houses a loading ramp within the inner cavity of the enclosure.

To achieve the above objects, in an aspect of the present invention, a combination loading device is described comprising a running board enclosure, where the running board enclosure attaches to a side of the truck to serve as a running board; an inner cavity within the running board enclosure; a loading ramp within the inner cavity of the running board enclosure, where the loading ramp attaches to a truck bed; an attachment end of the loading ramp, where the attachment end fastens to the truck bed; and a loading end of the loading ramp at an opposite end from the attachment end, where the loading end rests on the ground during use.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a side view of a combination loading device in accordance with a first embodiment of the present invention;

FIG. 1(A) depicts a side view of a combination loading device in an open position in accordance with an exemplary embodiment of the present invention;

FIG. 2 depicts a side view of a combination loading device in accordance with a second embodiment of the present invention; and

FIG. 3 depicts a side view of a combination loading device in accordance with an exemplary embodiment of the present invention.

Like reference numerals refer to like parts throughout the description of several views of the drawings.

### DETAILED DESCRIPTION OF THE DRAWINGS

The present invention relates to a truck accessory that provides a side running board with a truck ramp combined into a single device. The invention provides a combination loading device as a truck accessory that provides a consumer with a running board and a truck ramp in a single tool. The combination loading device is an easy to use and lightweight tool that is capable of supporting weight up to 800 pounds. To use, the user simply unfastens the modified running board from the side of the vehicle, and attaches the running board to the back of a truck to serve as a loading ramp.

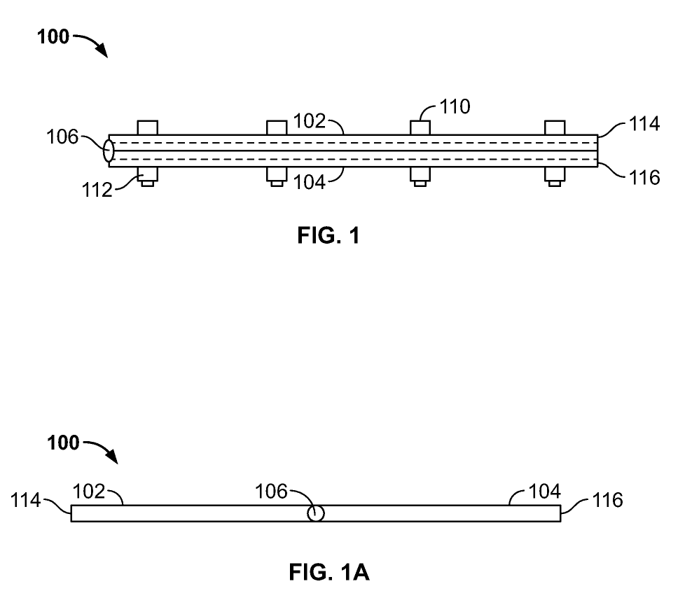

Turning now descriptively to the drawings, referring to FIG. 1, a side view of a combination loading device 100 is shown in accordance with an exemplary embodiment of the present invention. The combination loading device 100 includes a first platform 102 and a second platform 104, the first platform 102 positioned atop the second platform 104. The first platform 102 is attached to the second platform 104 at a joint 106. The joint 106 pivots the first platform 102 upon the second platform 104 to enable movement from a folded position (as seen in FIG. 1) to an open or flat position (as seen in FIG. 1(A)). In the open position the first platform 102 is positioned adjacent to the second platform 104 to embody a loading ramp. The joint 106 locks when in the open position to prevent the first platform 102 and the second platform 104 from bending or collapsing during use. The first platform 102 and the second platform 104 are made from a durable, strong and lightweight material like aluminum for easy maneuverability while still supporting a substantial amount of weight.

At an end of the first platform 102 opposite to the joint 106 is an attachment end 114. Similarly, at the opposite end of the second platform 104 from the joint 106 is a loading end 116. When the combination loading device 100 is in the open position the attachment end 114 fastens to the back of a truck bed, while the loading end 116 rests on the ground. This way the combination loading device 100 serves as a loading ramp for the vehicle.

The combination loading device 100 attaches to the side of the truck with a set of attachment means 110. The attachment means 110 may be J-hooks, or brackets to fasten the first platform 102 and the second platform 104 along the side of the truck. When attached to the side of the truck, the combination loading device 100 serves as a running board. The user steps on the first platform 102 to enter into the truck cabin. Beneath the second platform 104 are a set of locks 112 to secure the first platform 102 and the second platform 104 to the set of attachment means 110. The locks 112 may be twisting locks that screw into the attachment means 110.

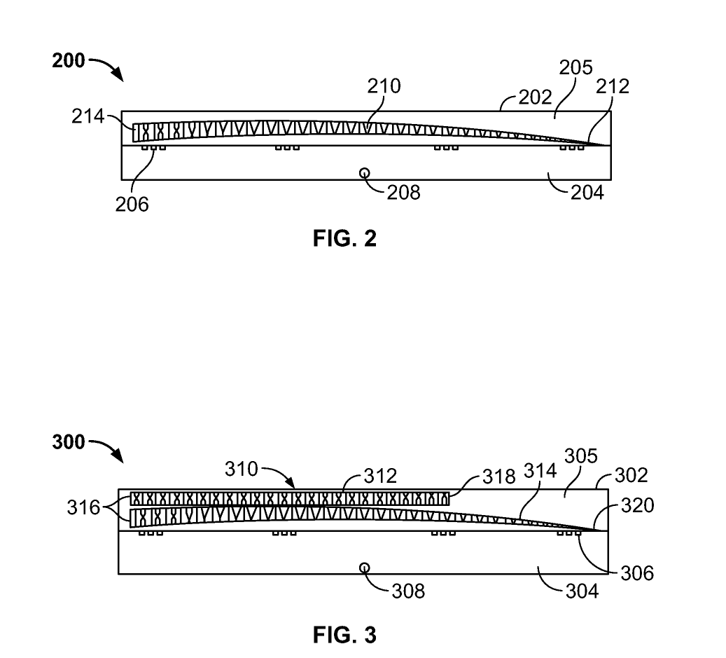

Referring now to FIG. 2, a side view of a combination loading device 200 is shown in accordance with a second embodiment of the present invention. The combination loading device 200 includes a running board enclosure 202. The running board enclosure 202 is a boxed structure that is mounted to the side of the truck. The top surface of the running board enclosure 202 serves at the stepping portion to allow the user to enter the truck cabin. The running board enclosure 202 includes a door 204 that opens and closes against the front face of the running board enclosure 202. The door 204 opens on a set of hinges 206 and is locked in shut with a securing means 208. The securing means 208 may be a magnet, latch, hook and eye or the like to keep the door 204 fastened against the running board enclosure 202.

Within an inner cavity 205 of the running board enclosure 202 is a loading ramp platform 210. The loading ramp platform 210 is removable from the running board enclosure 202 for use as a loading ramp that attached to the back of the truck. The running board platform 210 includes a loading end 212 and an attachment end 214, where the attachment end 214 fastens to the truck bed. The loading end 212 may be tapered for easier access to the wheeled vehicles that use the loading ramp platform 210. During use, the running board enclosure 202 is opened to remove the loading ramp platform 210. The loading ramp platform 210 is then attached to the truck bed for use when loading items onto the truck.

Referring now to FIG. 3, a side view of a combination loading device 300 is shown in accordance with a third embodiment of the present invention. The third embodiment of the present invention combines both the first embodiment and the second embodiment. The combination loading device 300 includes a running board enclosure 302 with a door 304 attached on hinges 306 that locks with a securing means 308. The running board enclosure 302 is similar to the running board enclosure 202 illustrated in FIG. 2.

The running board enclosure 302 houses a loading ramp 310 that folds upon itself like the embodiment illustrated in FIG. 1. The loading ramp 310 includes a first platform 312 and a second platform 314 that attach to each other at a joint 316. The first platform 312 unfolds from atop the second platform 314 to an open position, as illustrated in FIG. 1(A). The first platform 312 includes an attachment end 318 that fastens to the truck bed. The second platform 314 includes a tapered loading end 320 that rests on the ground.

During use, the securing means 308 of the running board enclosure 302 unlocks to open the door 306 and access the inner cavity 305. The loading ramp 310 is removed from the enclosure 302, and unfolded to allow the first platform 312 to rest adjacent to the second platform 314. The joint 316 is locked to ensure that the loading ramp 310 does not collapse during use. The attachment end 318 is then fastened to the truck bed while the loading end 320 rests on the ground. After loading the desired items onto the truck bed, the loading ramp is then folded and placed back into the running board enclosure 302. With the combination loading device, the user is afforded the ability to easily convert their running board into a loading ramp. Also, with the running board enclosure, the loading ramp is hidden away in a compact form until needed for use.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A combination loading device for a truck comprising:
a. a running board enclosure, where the running board enclosure attaches to a side of the truck to serve as a running board;
b. an inner cavity within the running board enclosure;
c. a loading ramp within the inner cavity of the running board enclosure, where the loading ramp attaches to a truck bed;
d. an attachment end of the loading ramp, where the attachment end fastens to the truck bed; and
e. a loading end of the loading ramp at an opposite end from the attachment end, where the loading end rests on the ground during use.

2. The combination loading device according to claim 1, where the running board enclosure includes a door to contain the loading ramp within the inner cavity.

3. The combination loading device according to claim 2, where the door attaches to the running board enclosure on a set of hinges.

4. The combination loading device according to claim 2, where the door includes a securing means to fasten the door to the running board enclosure.

5. The combination loading device according to claim 1, where the loading ramp includes a first platform and a second platform connected at a joint.

6. The combination loading device according to claim 5, where the loading ramp moves from an open position and a folded position, where in the open position the first platform is adjacent to the second platform, and where in the folded position the first platform rests atop the second platform.

7. The combination loading device according to claim 6, where loading ramp is in the folded position when inside the running board enclosure, and where the loading ramp unfolds to the open position when attached to the truck bed.

8. The combination loading device according to claim 1, where the loading end is tapered.

9. A method of use for a combination loading device for a truck comprising the steps of:
a. opening a door attached on hinges to a running board enclosure, where the running board enclosure is attached to a side of the truck;
b. removing a loading ramp from an inner cavity of the running board enclosure;
c. fastening the loading ramp to a truck bed;
d. loading the truck bed using the loading ramp; and
e. placing the loading ramp back into the running board enclosure.

10. The method of use for the combination loading device according to claim 8 further comprising the step of unlocking a fastening means on the door before opening the door.

11. The method of use for the combination loading device according to claim 8 further comprising the step of unfolding a first platform of the loading ramp from a second platform of the loading ramp after removing the loading ramp from the inner cavity of the running board enclosure.
